(19) United States
(12) Patent Application Publication
(10) Pub. No.: US 2021/0165923 A1
(43) Pub. Date: Jun. 3, 2021

(54) THREE DIMENSIONAL DRAWING TOOL AND METHOD

(71) Applicant: GOGGLE COLLECTIVE LTD., Guildford Surrey (GB)

(72) Inventor: Neil Johnston, Guildford Surrey (GB)

(21) Appl. No.: 16/770,523

(22) PCT Filed: Dec. 5, 2018
(86) PCT No.: PCT/EP2018/083618

§ 371 Date: Jun. 5, 2020

(30) Foreign Application Priority Data
Dec. 6, 2017 (GB) 1720354.8

(51) Int. Cl. G06F 30/12; G06F 3/01; H04N 13/366; H04N 13/275; G06F 3/03

(52) U.S. Cl. CPC G06F 30/12; G06F 3/011; G06F 2111/18; H04N 13/275; G06F 3/0304; H04N 13/366

(57) ABSTRACT

A virtual reality design tool comprises a headset (1) and a controller (12). The headset (10), worn by a user, displays three-dimensional virtual reality (VR) space (18). The VR space has tools such as a virtual controller (19) that the user can use for free-drawing of lines (300) in the VR space. Such lines can be created and edited, particularly by dragging of control points in three dimensions using the virtual controller (19).

### FIELD OF THE INVENTION

This invention relates to drawing tools, for example to assist in the drawing and design of motor cars and other vehicles, but generally for computer-aided design in three dimensions.

### BACKGROUND

Splines are used by draftsmen to draw curved shapes. In computer-aided design (CAD), a spline is defined by a mathematical algorithm, typically a function defined piecewise by polynomials, typically a sequence of individual curves joined to form a larger curve. Some drawing packages make use of cardinal splines. A cardinal spline is specified by an array of control points on a curve, and a tension parameter. Once a spline has been generated, the control points can be moved in order to edit the spline. Cardinal splines are typically drawn in 2D and have limitations. For example, if the tension parameter is too high, it is not possible to draw tight curves but if the tension parameter is too low, the curve may have an appearance that it unduly organic for particular applications, and may require excessive editing to devise a shape to the designer's satisfaction.

When drawing in 3D, most CAD tools require that a particular 2D plane is selected, and features are projected onto that plane. Editing can be performed in the selected plane or perpendicular to it. For example, control points of a line can be moved in the selected plane or perpendicular to it. If a curved line is edited in this way, it is often necessary to select different views to fully visualize the effect of a change.

U.S. Pat. No. 5,412,770 describes a method of reshaping parametrically expressed free forms on a CAD system by simultaneously moving multiple control points.

In the field of automotive design and nautical and aeronautical design, there is an increasing need to be able to generate and edit 3D virtual representations of vehicles, aircraft and the like with smooth curves, in particular aerodynamic curves. This needs to be achieved with speed and ease of use and deliver a result with minimum of editing.

The use of virtual reality is of growing importance to many design-based industries. Typically, a user will make use of a headset and one or more controllers to access tools in a virtual reality environment. The tools are then used to create and edit representations of three-dimensional objects in the virtual reality environment.

US2016/0370971A1 describes systems and methods for producing a representation of a display of a three-dimensional virtual reality environment and defining a dress form object within the virtual reality environment. Tools are provided to modify images by drawing, drafting, painting, scribbling, moving, illuminating or shadowing.

U.S. Pat. No. 6,629,065 B1 describes expanding and moving existing shapes.

There is scope for improving the ease-of-use of 3D CAD tools, particularly for drawing of objects having smooth continuous, graceful curves, such as vehicles, aeroplanes, boats, etc. that have aerodynamic qualities.

### SUMMARY OF THE INVENTION

A drawing tool is provided for assisting in the preparation of drawings of a three dimensional, 3D, object, including: a stereoscopic display for creating a 3D virtual reality image of the object being drawn; means for tracking movement of a pointer in three dimensions in real space; means for representing a line as a spline or a set of adjoining splines having control points; means for presenting the line and its control points in 3D virtual space and for representing the pointer as a virtual pointer in the same 3D virtual space; and means for selecting an edit function by which movement of the pointer in real space causes movement of the virtual pointer in the 3D virtual space and causes a control point in the 3D virtual space to move in three dimensions and thereby change the shape of the line in three dimensions.

The pointer is preferably a hand-held device such as a controller or a stylus having means for receiving start-of-line and end-of line inputs. The stylus may have infra-red sensors or an infra-red source and complementary sources or sensors are provided for measuring the position of the stylus.

A processor can record the position of the pointer from start to end of a free-drawn line, whereby movement of the controller in real space between the start-of-line and end-of-line inputs causes a free-drawn line to be created in the 3D virtual space.

The splines are preferably B-splines with a set of adjoining straight lines generated associated with the line. The straight lines are connected at control points and have a first line, a last line and at least one line therebetween. The first line has the same gradient as the start of the free-drawn line, the last line has the same gradient as the end of the free-drawn line and the free-drawn line is fitted to the straight lines by a curve-fitting function.

The processor computes the splines, the straight lines and the control points, and preferably selects the straight lines and the control points according to a distance-minimizing function that minimizes distances between samples on the splines and samples on the straight lines.

The splines are preferably constrained to third-order polynomial functions. Adjacent splines preferably join each other at a knot where the gradient of one spline matches the gradient of the adjacent spline.

A method of drawing a line in three dimensions is also provided. The method comprises: waving a pointer from a start position to an end position while viewing a track of the stylus using a virtual reality stereoscopic imaging device; recording the track of the pointer in three dimensions; presenting, in three dimensional virtual space, a representation of the track as a line together with a series of straight lines to which the line is curve-fitted, the straight lines being connected by control points; causing one of the control points to be moved in three-dimensional virtual space; re-calculating the curve-fitted line according to the new control point; and re-presenting the line.

The method may include causing an end-of-line control point of a first line to be moved to connect with a second line in the virtual space and to be joined to the second line. Joining of the control point of the first line to a control point of the second line followed by movement of the joined control point preferably causes both lines to be re-shaped. Joining of the control point of the first line to a mid-line position on the second line preferably causes movement of the control point of the first line to be constrained to the locus of the second line.

Joining of a plurality of lines in a closed perimeter may, upon user command, cause a surface to be calculated and selectively displayed. Selection of a virtual command to fill the surface preferably causes the surface to be displayed with a selected colour or texture.

The method may also comprise selecting a plane of symmetry, wherein the step of presenting the line includes presenting a symmetrical image of the line and wherein the step of moving a control point on one side of the plane causes the line and its symmetrical image to be re-shaped and re-presented.

Causing a control point at the end of the line (or its mirror image) to be moved to the plane of symmetry preferably causes the line and its symmetrical image to meet and join.

Lines can be joined to each other in a number of ways. One way is by causing a control point of a first line (e.g. the end) to occupy the same position as a control point on a second line (e.g. the end of the second line). The two control points become one, common, control point. Moving that control point causes both lines to change shape.

Connecting two points with precision can be very difficult, especially in 3D virtual reality. The need for precision is avoided by use of “auto snapping”. The user explicitly requests to join two splines, and they are then connected via their nearest points—which may be at their ends (e.g. to form an L shape), or an end-to-middle (to form a Y shape) or middle-to-middle (to form a X shape). In each case, the junction becomes the shared end control point of the resulting 2-4 splines as described. The user merely has to position the two splines close to each other to ensure the desired result.

A particular case of this type of joining is the bringing of a spline's control point to the central plane, causing it to meet and automatically link with its mirror image. This causes the ends of the two lines to be locked to a point on the central plane. (Apart from this, two lines joined in this particular scenario behave like any other two connected lines. Indeed they still behave like a symmetrical pair of lines subject only to that constraint—neither of them can be removed from the central plane.)

The step of presenting a symmetrical image of the line preferably includes presenting a symmetrical image of the series of straight lines and the step of causing the line and its symmetrical image to meet preferably also causes the series of straight lines and their symmetrical image to join. In this way, a control point at the end of the curve-fitted line and a control point at the end of its mirror image become a single control point.

A preferred embodiment or embodiments of the invention will now be described, by way of example only, with reference to the accompanying drawings.

### BRIEF DESCRIPTION OF THE DRAWINGS

FIG. 1 is a diagram that shows a headset accessing virtual reality content with a computing device in VR space.

FIGS. 2A-C are example screenshots of interactive regions in VR space.

FIG. 3 is an example screenshot of lines being drawn in VR space.

FIG. 4 is an example screenshot of a line about to be edited in VR space.

FIG. 5 is an example screenshot of a line being edited in VR space.

FIG. 6 is a flow diagram depicting a method of drawing lines in VR space.

FIG. 7 is a flow diagram depicting a method of editing lines in VR space.

FIG. 8 is a diagram of a B-Spline.

FIG. 9 is an example screenshot of a line and its mirror version in VR space.

FIG. 10 is an example screenshot of a line and its mirror version being moved closer together in VR space.

FIGS. 11A-B are example screenshots of interactive regions in VR space with and without a visible 3D core.

FIGS. 12A-B are example screenshots of a slider being used to change the depth of a 3D core in VR space.

FIG. 13 is an example screenshot of an interactive region in VR space.

FIG. 14 is a flow diagram depicting a method of drawing and editing surfaces in VR space.

### DETAILED DESCRIPTION

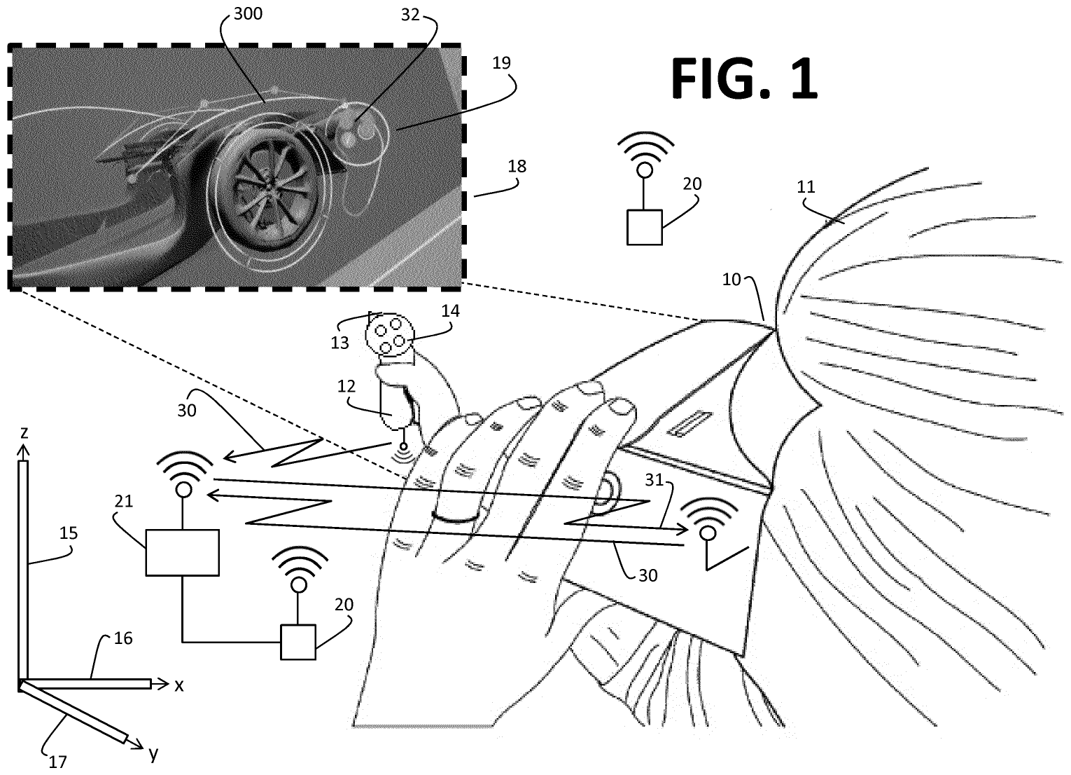

Referring to FIG. 1, a virtual reality design tool is shown that comprises a headset 10, a controller 12, base stations 20 and a computer 21.

The headset 10, to be worn by a user 11, displays three-dimensional virtual reality (VR) space 18. The VR space has tools in the form of a virtual controller 19 available for the user 11. The VR space 18 comprises one or more lines 300, the creation and manipulation of which will be discussed in further detail in due course.

The controller 12 comprises various buttons 14 and a plurality of IR sensors. (These are not shown, but there may be any number from 3 to 24 such sensors on different positions/faces of the controller.) The headset has similar IR sensors. The buttons 14 preferably comprise a trigger button, a grip button, a thumbstick and others. The controller may have a pointer 13, but (as will be explained) this has no function in the real world and merely represents a virtual pointer in the virtual world. An example of a controller is described in US2017/0139481A1.

The pointer 13 corresponds to the part of the virtual controller 19 that can interact with the VR space, similar to the way a mouse icon is displayed on a PC monitor.

The base stations 20 are connected (wired or wirelessly) to the computer 21. Although only two are shown, more can be implemented. The majority of inputs are received from the main controller 12, but if the user 11 has a second controller in the other hand, the application can be configured to receive inputs from this controller as well. The user 11 can flip the control scheme from one hand to the other.

In FIG. 1, the user's hand is shown holding a visor of the headset 10. It will be understood, however, that the user 11 is preferably provided with a second controller (e.g. similar to controller 12) with auxiliary inputs on the second controller. These can be swapped for right/left handedness of the user. Alternatively, the user 11 may use another type of controller, such as a pushbutton or a pedal.

In operation, the base stations 20 emit infra-red signals modulated with synchronization signals. These are received by the plurality of sensors on the controller 12 and on the headset. Upon receiving a signal from the base stations 20, the sensors measure the time of receipt of the synchronization signals and report these by wireless signals 30 to the computer 21. The computer 21 can then determine the distance of each of the plurality of sensors from the base stations 20 based on the respective time intervals between the transmitting and receiving of the infra-red signals. In this way, the computer 21 can calculate the absolute position and orientation of the controller 12 and of the headset 10 at any time.

(Alternatively, the controller may have IR transmitters and there may be multiple IR sensors distributed in the vicinity at the base stations, in which case the base stations measure the time of receipt of the IR signals from the controller.)

This information is used to generate the image to be displayed, and the image is relayed by wireless signals 31 to the headset 10, which also displays the position and orientation of the controller 12 in the VR space 18 in the form of the virtual controller 19.

The motion of the controller 12 through 3D space, denoted by a z-axis 15, an x-axis 16 and a y-axis 17, can then be matched by the motion of the virtual controller 19 through VR space.

The virtual controller 19 comprises virtual buttons 32, which correspond to the buttons 14 on the controller 12. Pressing the buttons 14 simultaneously causes the virtual buttons 32 to change colour/shade or show some other manifestation of having been pressed, enabling the user 11 to interact with the VR space. The controller 12 may provide haptic feedback to the hand of the user 11.

Alternatively, instead of a stylus-like controller with IR transmitters and sensors, the apparatus could comprise a pair of cameras in different viewing planes, and image-recognising software that is configured to recognise and track a pointer, such as the tip of the user's finger.

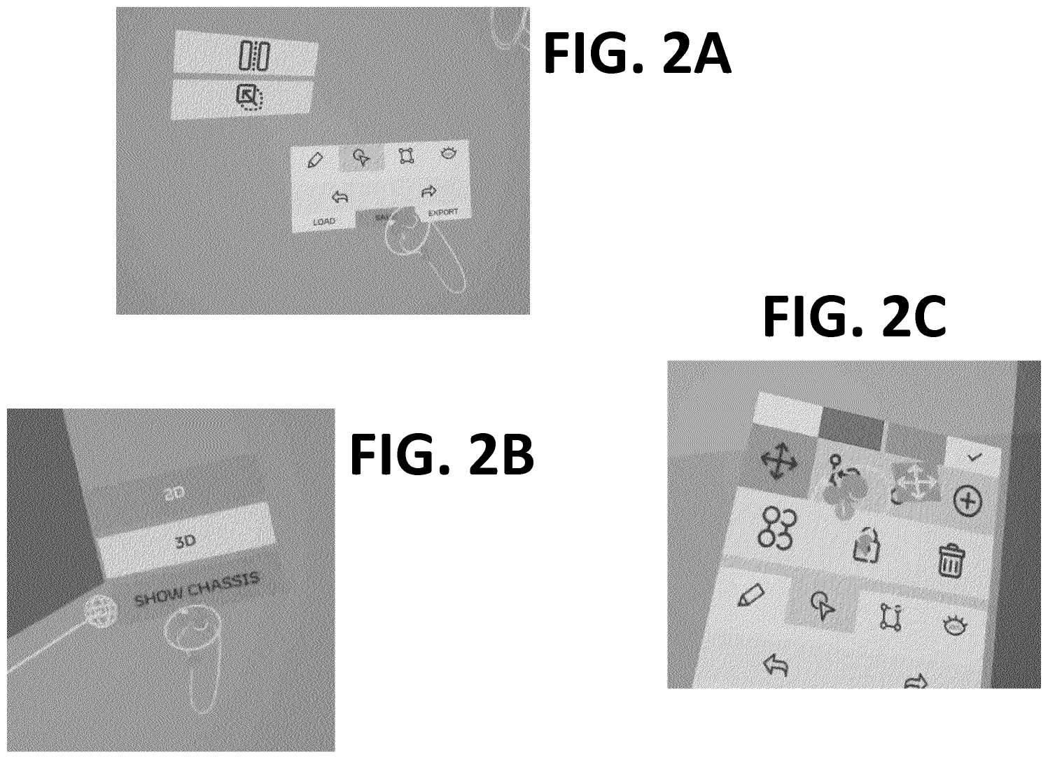

Referring now to FIGS. 2A-C, three different screenshots of VR space 18 are shown. Depending on the direction in which the user 11 is looking, FIG. 2A, 2B or 2C may appear in the VR space. Each figure shows different buttons in VR space.

The buttons shown in VR space can be interacted with and their associated tools can then be selected by moving the controller 12 to align the virtual controller 19 with the required area of the VR space and pressing one or more of the relevant buttons 14. For example, there may be a “show chassis” button, which enables the user 11 to view the 3D core 350 of the design, manifested in this case as a car chassis. There may be buttons to toggle between 2D and 3D editing. There may also be buttons to enable the user 11 to save, load, or delete designs. When toggling between two alternative modes, the wording on a virtual button changes to the opposite mode. This is illustrated in FIG. 2B for the commands SHOW CHASSIS and HIDE CHASSIS but could equally be used to toggle between 3D mode and 3D mode (and for other functions).

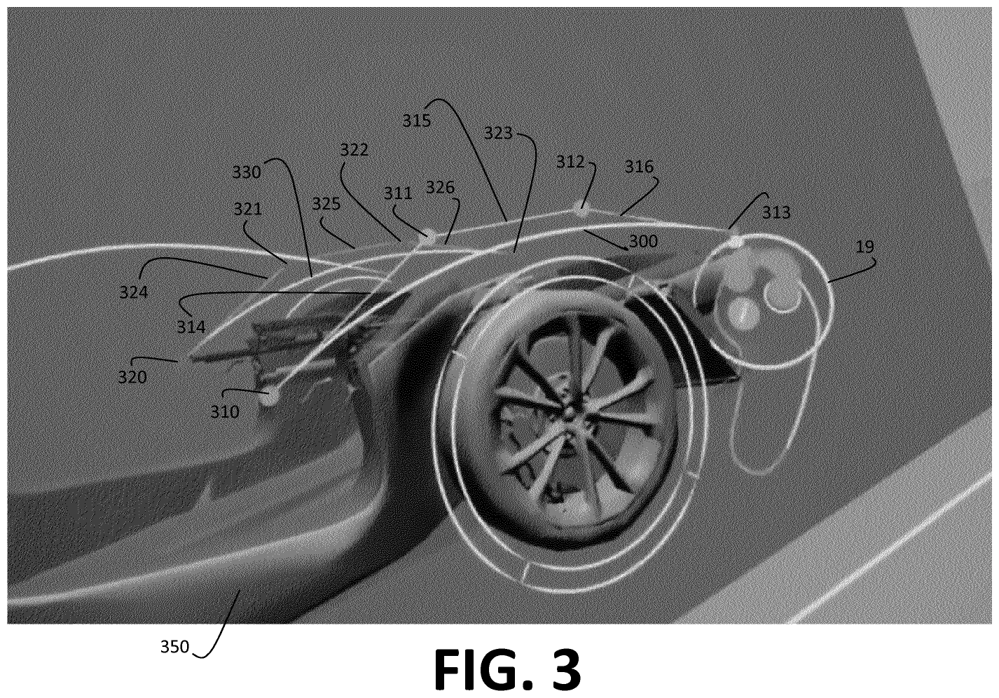

Referring now to FIG. 3, the VR space 18 may display a line 300, an associated mirror line 330 and a 3D core 350, in this case manifested as a car chassis. Not shown in FIG. 3 is a virtual mirror running through the 3D core 350 from left to right with respect to FIG. 3.

After drawing a line 300 in VR space using the controller 12, control points 311 and 312 will also be generated, joined together by a straight line 315 and connected to the ends 310 and 313 of the line 300 by straight lines 314 and 316. It should be noted that the controls points 311 and 312 are not on the line 300 being controlled by the control points. It should also be noted that the ends 310 and 313 of the line 300 are both also control points.

As a line 300 is generated, a mirror line 330 will also be created. The mirror line is formed by reflecting the line 300 in the virtual mirror. The control points 311 and 312 also have associated mirror control points 321 and 322, joined together by a straight line 325 and connected to the ends 320 and 323 of the mirror line 330 by straight lines 324 and 326.

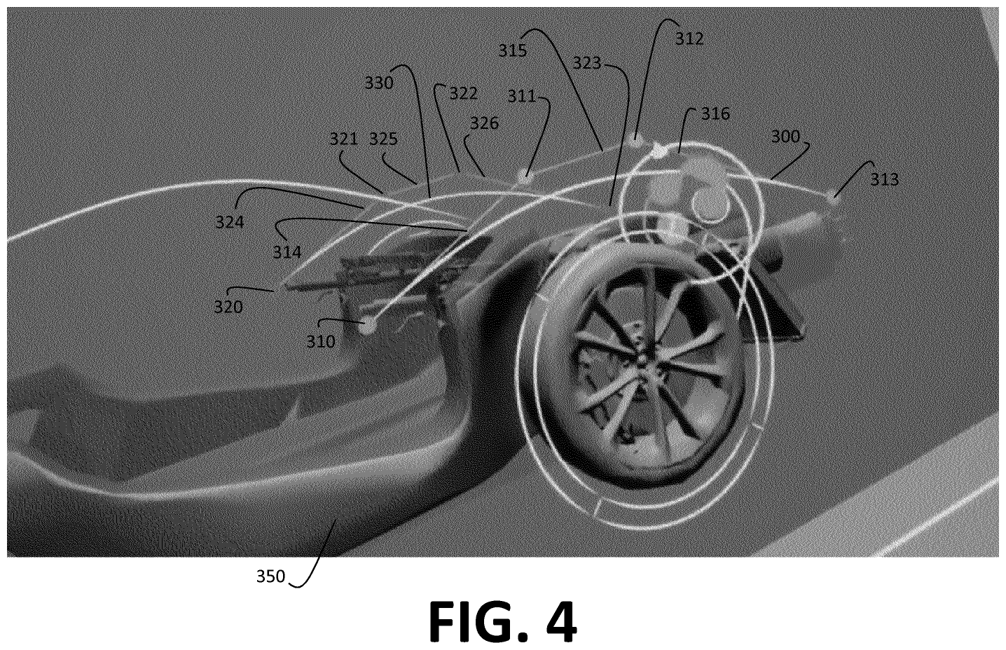

Referring now to FIG. 4, the VR space 18 is shown to display the line 300 as it is about to be edited.

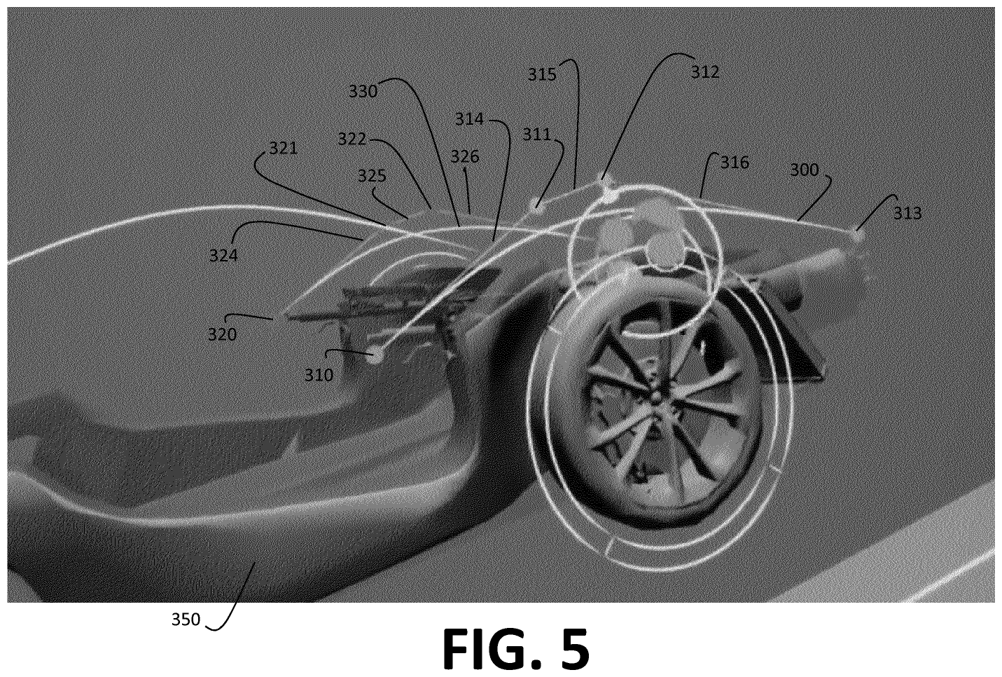

A control point 312 of the line 300 is selected by moving the controller 12 through 3D space to align the virtual controller 19 with the required control point 312. A control button is depressed or otherwise activated (as will be described). The shape and length of line 300 can then subsequently be edited, as described with reference to FIG. 5.

Referring now to FIG. 5, the VR space 18 displays the line 300 being edited.

As control point 312 is selected and moved to the left with respect to FIG. 4 through VR space using the controller 12, the shape and length of line 300 changes depending on the new placement of the control point 312.

The mirror control point 322 of mirror line 330 simultaneously moves through VR space in the same manner and the shape and length of mirror line 330 also changes accordingly. The connecting straight lines 314, 315 and 316 and their corresponding mirror straight lines 324, 325 and 326 also move accordingly. The ends 310 and 313 of line 300 do not move when control point 312 is moved, nor do the corresponding ends 320 and 323 (hidden from view in FIG. 5) of mirror line 330.

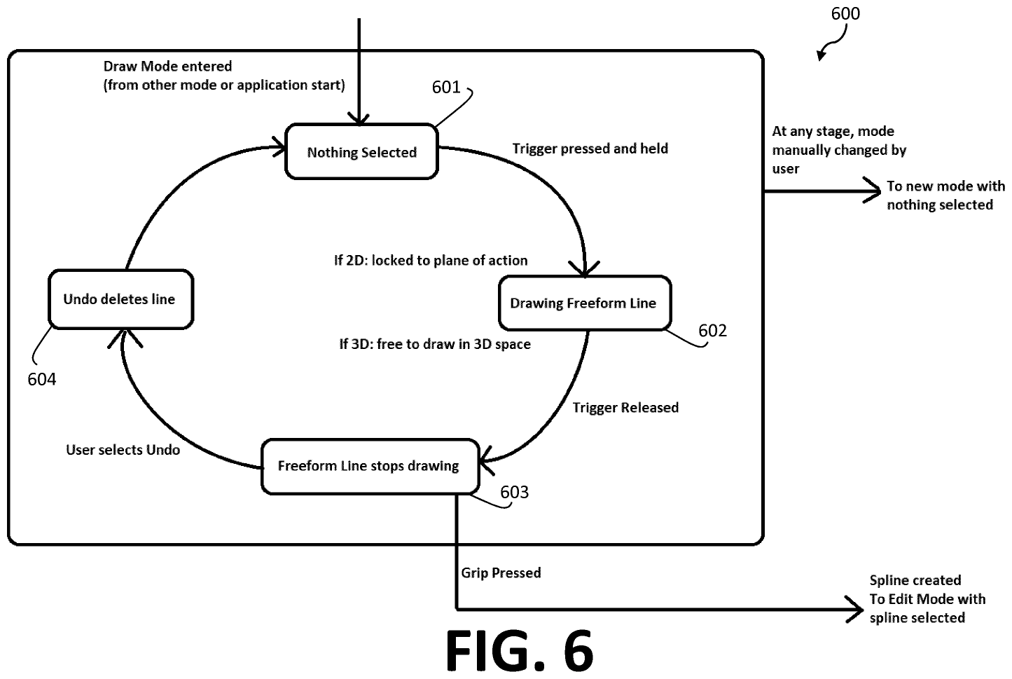

Referring now to FIG. 6, a flow diagram 600 depicts a method for drawing a line in VR space. It should be appreciated that not all steps need be followed in this method.

When the application is launched, it begins in Draw mode. The user can at any point manually switch to Edit mode or to Surface mode.

At block 601, the application is in Draw mode, having arrived there either by switching from another mode or from the application start. Nothing is selected at this stage.

At block 602, the user 11 begins to draw a freeform line. If the user is drawing in 2D, the line will be locked to the plane of action. If the user is drawing in 3D, they are free to utilise all the 3D space in VR. The user uses the buttons 14 on the controller 12, preferably the trigger button, to draw a line. The user presses and holds the trigger button to create the starting point of the line. Still holding the trigger button, the user moves the controller 12 freely, causing a line to be drawn matching the movements of the controller 12.

At block 603, the user stops drawing a freeform line. The user releases the trigger button and the line stops being drawn. At this stage, the user can then switch to Edit mode by using the buttons 14 on the controller 12, preferably the grip button. The user presses the grip button and the line is converted into a spline via a curve fitting algorithm (described below). This spline is automatically selected and the user may proceed to Edit mode.

To the user 11, it appears as though the line has been “painted” in mid-air or other position in relation to the core chassis.

For many applications of the invention, the user expects to create something symmetrical. As the line is being drawn, a mirror line is also drawn on the opposite side of the virtual mirror. If the line is later edited or deleted, the mirror line will also be edited or deleted in the same way.

Alternatively, the user may decide to proceed to block 604 and delete the line. The user can select the undo command, which deletes the line. The user then arrives back at block 601 and can repeat the previous steps.

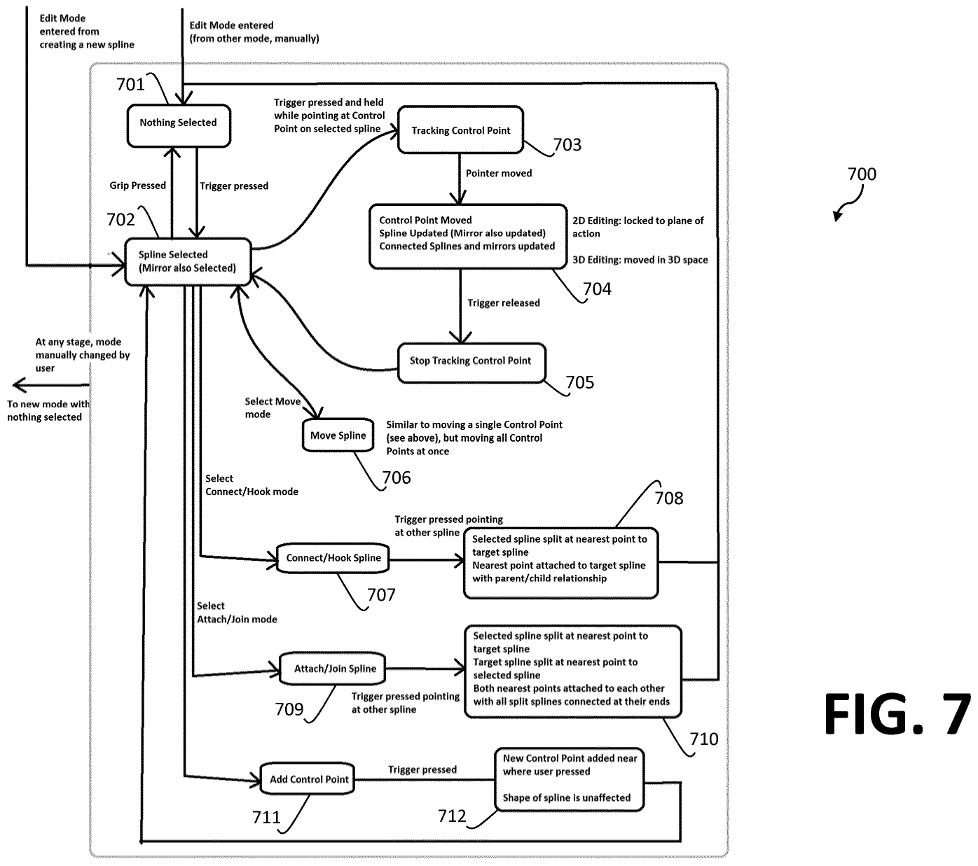

Referring now to FIG. 7, a flow diagram 700 depicts a method for editing a line in VR space. It should be appreciated that not all steps need be followed in this method.

Throughout this method, the application program is in Edit mode, having arrived there manually from another mode, or automatically after creating a new spline (see FIG. 6). At any stage, the user can leave the method by manually selecting another mode. The user will then switch to the new mode with nothing selected.

If the user has entered Edit mode manually, the process begins at block 701, with nothing selected.

The user can then proceed to block 702 by selecting a spline. The user moves the controller 12 to align the virtual controller 19 with the desired spline in VR space. The user uses the buttons 14 on the controller 12, preferably the trigger button, to select the spline.

If the user has entered Edit mode automatically after creating a new spline, the process begins at block 702. The spline and its automatically-generated mirror version are both selected.

The user can return to block 701 by deselecting the selected spline. The user uses the buttons 14 on the controller 12, preferably the grip button, to deselect the spline. Nothing is selected and the user can then return to step 702 by selecting either another spline or the recently deselected one.

The user can then begin to edit the selected spline. At block 703, the user tracks a control point on the selected spline. The user moves the controller 12 to align the virtual controller 19 with the desired control point of the selected spline in VR space. The user uses the buttons 14 on the controller 12, preferably the trigger button, to select the control point. The user presses and holds the trigger button to select the control point.

Still holding the trigger button, the user moves the controller 12 freely, causing the control point to be dragged in a path matching the movements of the controller 12.

At block 704, as the control point is being moved, the spline is recalculated to show the effect of the movements. The lines connecting the selected control point with other control points and/or line end points also move accordingly. The mirror version of the spline also updates accordingly. If the user is editing in 2D, the control point will be locked to the plane of action. If the user is drawing in 3D, the control point can be moved to any position in VR space. Note that this dragging movement can be in any direction in the virtual space. Movement of the control point is not limited to a particular plane or dimension.

At block 705, the user stops tracking the control point. The user releases the trigger and the control point stops being moved. The user can then return to block 702 for further editing.

After selecting a spline at block 702, the user may decide to move the entire selected spline, rather than just a control point. The user can select Move mode, which enables the line to be moved. At block 706, the movement is carried out in a similar manner to blocks 703-705. After moving the spline, the user can then return to block 702 for further editing.

After selecting a spline at block 702, the user may decide to connect or hook it to a second spline. By selecting Connect/Hook mode, the program arrives at block 707.

The user moves the controller 12 to align the virtual controller 19 with a second spline in VR space. The user uses the buttons 14 on the controller 12, preferably the trigger button, to choose this second spline to hook the first spline to. The user presses the trigger button and the first spline hooks to the second spline.

At block 708, the nearest end of the first spline is hooked onto the nearest point of the second spline. The shape, position and control points of the second spline remain unchanged and so it acts as a parent spline in the new configuration. The appearance of the first spline and its dependencies is recalculated, since one of its control points has been moved. It acts as a child spline in the new configuration and can be moved along the parent spline without affecting the shape, position or control points of the parent spline. The user can then return to block 702 for further editing.

After selecting a spline at block 702, the user may decide to attach the selected spline to a second spline. By selecting Attach/Join mode, the program arrives at block 709.

The user moves the controller 12 to align the virtual controller 19 with a second spline in VR space and uses the buttons 14 on the controller 12, preferably the trigger button, to choose this second spline to attach the first spline to. The user presses the trigger button and the first spline attaches to the second spline.

At block 710, the nearest end of the first spline is connected to the nearest point on the second spline. If the nearest point of the second spline is at one of its ends, the two splines share the same control point at their ends. If the nearest point of the second spline is somewhere along its length, the second spline is split at that point into two new splines. These two new splines, along with the first spline, all share the same control point at their ends. The appearance of the first spline and its dependencies are recalculated, since one of its control points has been moved. The user can then cause the program to return to block 702 for further editing.

After selecting a spline at block 702, the user can then proceed to block 711 and add a control point. The user moves the controller 12 to align the virtual controller 19 with a point in VR space near the selected spline. The user uses the buttons 14 on the controller 12, preferably the trigger button, to choose a point at which to add a control point. The user presses the trigger button to add the control point.

At block 712, a new control point has been added to the spline at the point of the spline nearest to the point chosen by the user. The shape of the spline is unaffected. The user can then return to block 702 for further editing.

When a control point is added, existing control points may move according to the curve-fitting algorithm, so as to retain the shape of the curve despite it having one extra control point (because, for example, the sum-of-squares minimization results in a different solution when there is an extra control point). The user can then move and edit the spline as before.

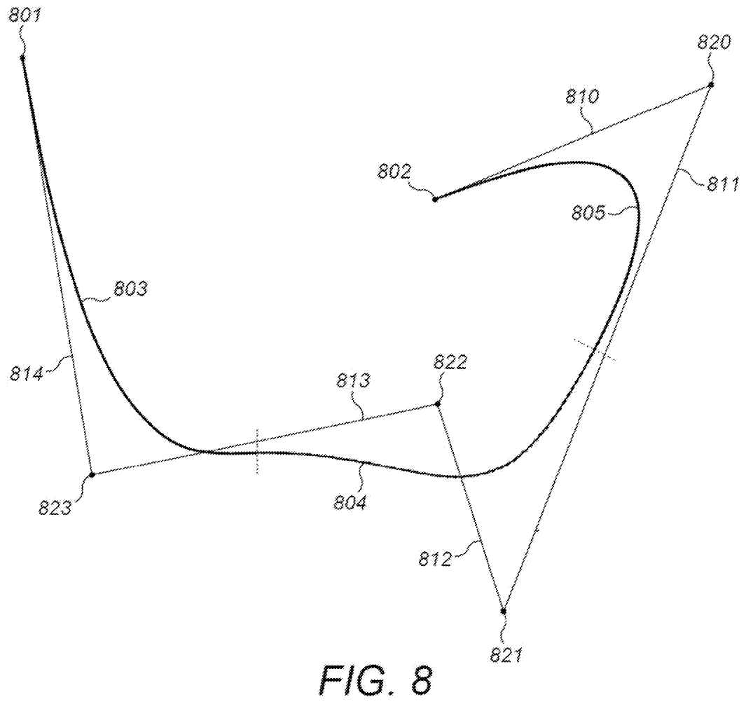

Referring now to FIG. 8, an example of a line represented as B-splines is shown. In this case, the line comprises three component curves (splines) 801, 802 and 803. The component curves join at positions (“knots”) shown by dashed lines, but these are of no consequence to the user of the system. The ends of the component curves and the dashed lines are not visible. They are shown here for explanation only. Each component curve has the same continuity properties as its adjoining component curve (e.g. same gradient in each of two dimensions—i.e. in the plane of the image as shown and in a perpendicular plane tangential to the line at the joining knot). This is a constraint on the component curve function.

Each curve is defined by a polynomial function. For example, curve 805 may be a second or third order polynomial. Curve 803 may also be a portion of a second or third order polynomial. Curve 804 may be a third order polynomial (or may be a second order polynomial subject to a curving constraint at the end where it adjoins curve 803). Each component curve may comprise sub-components (splines), in which case, each subcomponent may be a lower order polynomial.

The control points are sampled from user input in real time, so the number of sample points is proportional (within the upper and lower bounds) to the length of the resultant spline (or, more particularly, proportional to the time taken for the user to draw the line). A slowly drawn line will be given more control points than a quickly drawn line, up to the maximum number of control points (e.g. 6).

Each inflexion causes an additional control point to be added, subject to the same maximum. (I.e. a quickly drawn line with one inflexion will have one control point more than a line drawn in the same time but with no inflexions.)

The knots are not constrained to uniform spacing along the line.

The second derivative of a second order B-spline need not be continuous at the knots.

The curve “fits” or is “fitted to” a polygon (an open polygon) comprising straight lines 810, 812, 813 and 814. The end sections of the polygon (lines 814 and 810) have the same gradient as the line at the respective end points. The fitting function is preferably a least-mean-squared fitting function, as will be explained.

As well as end control points 801 and 802, the curve has intermediate control points 820, 821, 822 and 823 at the corners of the polygon (the intersections between straight lines).

In the present system, a line is preferably provided with 2 or 3 mid control points. A small number of control points contributes to simple, efficient editing of smooth elegant curves, but lines may be provided with as many as 5 or 6 control points (i.e. one at each end and up to 3 or 4 in the middle). The number is preferably a system design option but could be presented to the user as a user option.

In the illustrated example, there is an inflexion in the curve—i.e. a reversal of gradient as the curve flows from section 803 to section 804. For this reason, in the 2D example of FIG. 8, line 813 crosses the curve (and line 812 crosses back again). (It may be noted, of course, that when the line of FIG. 8 is a 3D line, it is possible that the appearance of an inflexion is merely an illusion and that there are no inflexions and no “crossing” of the curve by the sides of the polygon.)

Inflexions reflect the positioning of the control points. If a control point is moved, this may cause a new inflexion.

According to the fitting function, the straight lines of the polygon and their control points are selected such that the sum, for all incremental sections of the line, of distances between a point on the line and a corresponding point on the polygon, is minimized on a mean-squared basis.

For example, for a spline function of degree k, the fitting function seeks to minimize:

$${\sum }_{all x} {\{ W ( x ) [ y ( x ) - {\sum }_{i} {α}_{i} {B}_{i , k , t} ( x ) ] \}}^{2}$$

where W(x) is a weight and γ(x) is the datum value at x. The coefficients αᵢ are the parameters to be determined. The knot values may be fixed or they too may be treated as parameters.

The above equation measures the squared distance between a sample point and its corresponding curve point. The error function measures the total accumulation of squared distances. The control points are recursively selected to make this error as small as possible. The number of sample points may be selected according to the computational capacity and the desired speed of calculation, but does not need to be high (e.g. 100-1000 sample points are typical).

The order of the spline function (which may be second order but is preferably no higher than third order) and the number of control points are limited to allow the calculations to converge on a single solution.

As the polygon is fitted to the line, so too is the line fitted to the polygon. This means that, once the control points are selected, they can be moved and the fitting function defines a new line to fit to the new polygon.

It is a great advantage of the arrangement described that the line has a smoothly curving function, which is particularly important in the design of vehicles, because the smoothly curving function will have good aerodynamic properties.

When two lines are joined, there is no smoothing of their functions at the join.

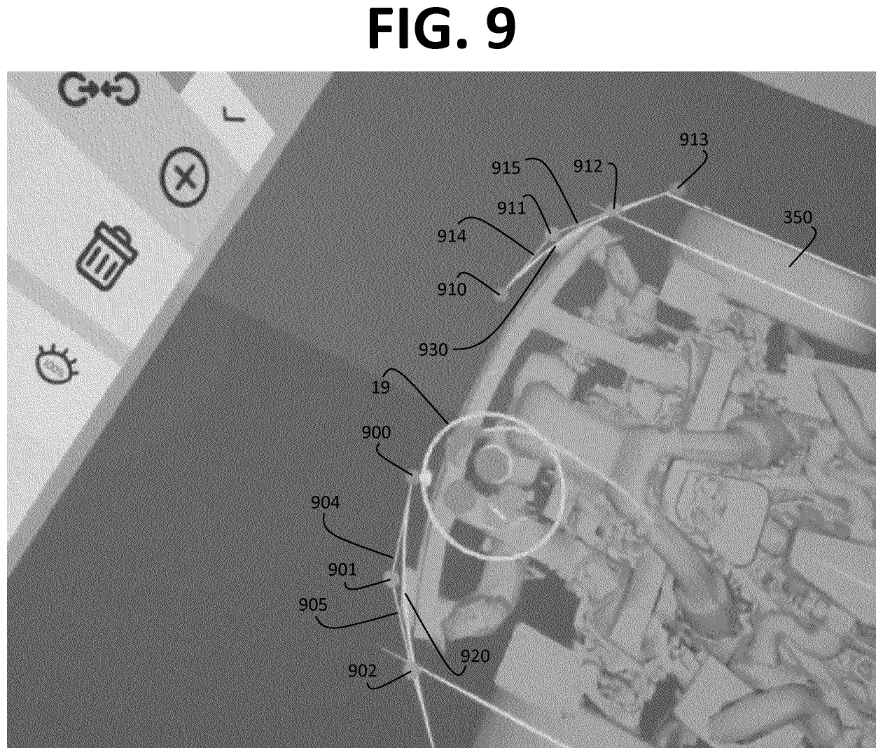

Referring now to FIG. 9, the VR space 18 may display a line 920, its associated mirror line 930 and the 3D core 350, in this case manifested as a car chassis. Not shown in FIG. 9 is a virtual mirror running through the 3D core 350 from top-left to bottom-right with respect to FIG. 9.

After drawing a line 920 in VR space using the controller 12, control points 901 and 902 will also be generated, joined together by a straight line 905 and connected to the ends 900 and 903 (not visible in this figure) of the line 920 by straight lines 904 and 906 (not discernible from line 920 in FIG. 9).

As a line 920 is generated, a mirror line 930 will also be created. The control points 901 and 902 also have associated mirror control points 911 and 912, joined together by a straight line 915 and connected to the ends 910 and 913 of the mirror line 930 by straight lines 914 and 916 (not discernible from line 930 in FIG. 9).

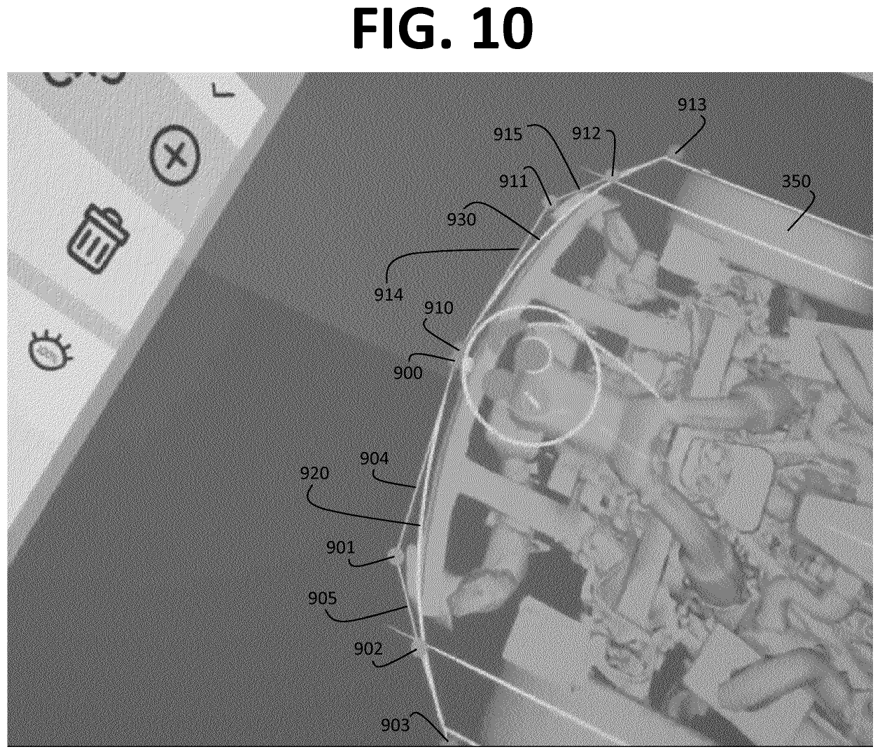

Control point 900 of line 920 is selected by moving the controller 12 through 3D space to align the virtual controller 19 with the required control point 900. The shape and length of line 920 can then subsequently be edited, as described with reference to FIG. 10.

Referring now to FIG. 10, the VR space 18 may display line 920 being edited, associated mirror line 930 and the 3D core 350.

As control point 900 is selected and moved to up with respect to FIG. 9 through VR space using the controller 12, the length of straight line 904 changes depending on the new placement of the control point 900. This in turn causes the shape and length of line 920 to change. The mirror control point 910 of mirror line 930 simultaneously moves down through VR space towards control point 900 and the shape and length of mirror line 930 also changes accordingly.

When the control point 910 meets the control point 900, the two lines 920 and 930 merge into a single line. This can be automatic, in which case the lines behave as if one sticks to the other, or it can be user-driven by activation of a “join” button.

When two lines are joined, they retain their status as two lines. They cannot be manipulated together except in the very special case of when the two lines are actually one line and its mirror reflection, which is in fact the case in FIG. 9. In this case, the two are moved together only because one is moved and it will cause its reflection to match its movements.

In cases where two lines are joined without being mirrors of each other, moving of one control point does not move “the whole line”. The whole line can be selected and moved (translated, rotated or both) by selecting the Move command 706.

The invention is not necessarily limited to shapes that are defined by spline functions. The system and methods described can be used with shapes defined by other functions. For example a circle (e.g. part of a wheel or an entire wheel) can be drawn in virtual space either by free-drawing a circle or by drawing a radius (or a spoke) and causing the tool to display a circle/wheel of that radius.

In the case of a wheel, it can be presented with radius and thickness and with control points for each, whereby the user can select a radius control point and drag it inwards or outwards to reduce or expand the radius (with the movement of the control point constrained along a radial locus) or the user can select a width control point and expand or reduce the width of the wheel (with the movement of the control point constrained along an axial locus).

Circles and wheels can have the same selection, attaching, splitting and editing functions as have been described above for lines. In the case of splitting, for example, a function may be provided to divide a circle or wheel into sectors that retain their link to the original circle centre.

Similarly, a box frame can be drawn as a unit with control points for expanding or reducing in three dimensions and with the ability to join other lines to the box frame. In the case of joining a control point of a line to a control point of a box frame, movement of that control point will cause the line to change shape and cause the frame to change size, but the frame will maintain its box shape.

As has been described, the newly described tool provides functions that are specific to splines (drawing a freeform line, curvefitting it, editing control points) and functions that are more generic than splines (attaching one part of a model to another, mirroring, creating surfaces between edges, etc).

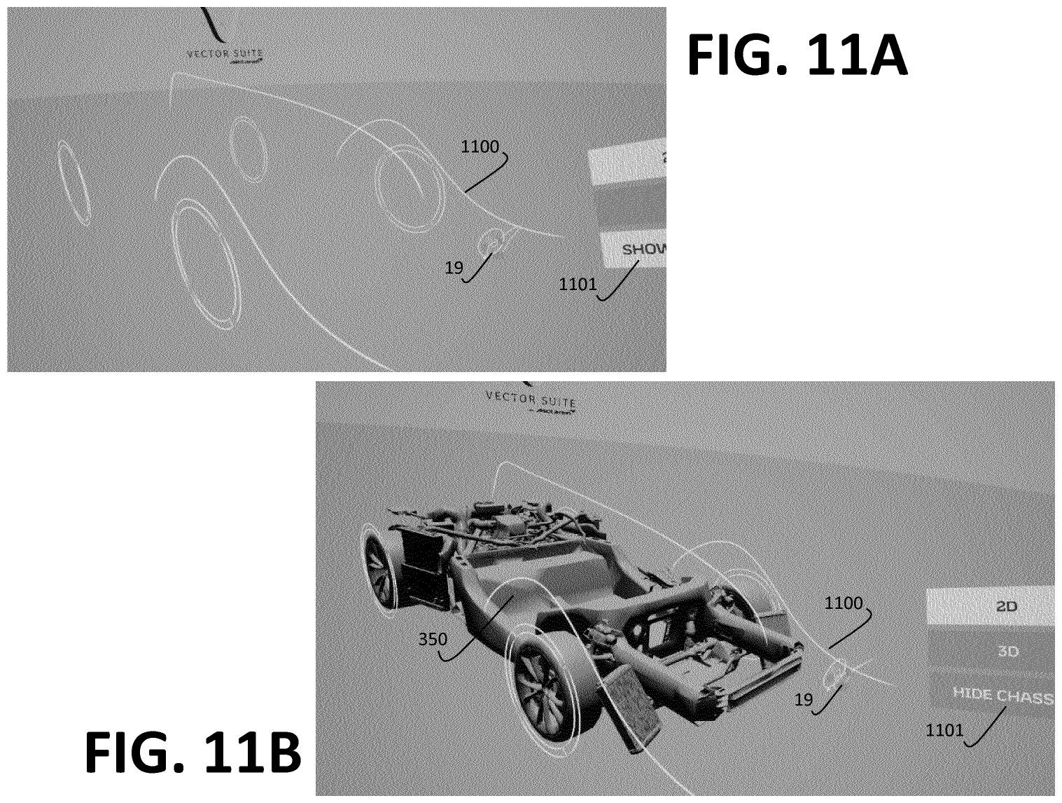

Referring now to FIG. 11A and FIG. 11B, two different screenshots of VR space 18 are shown. In FIG. 11A, the 3D core 350 is invisible. Only one or more lines 1100 are visible. The user 11 can use the controller 12 to align the virtual controller 19 with the interactive button 1101. If the 3D core 350 is invisible, as in FIG. 11A, the button 1101 will display the text “Show chassis”.

In FIG. 11B, the user 11 has selected this button, meaning that the 3D core 350 is now visible. The button 1101 now reads “Hide chassis”. The user 11 can select this button again to hide the 3D core 350.

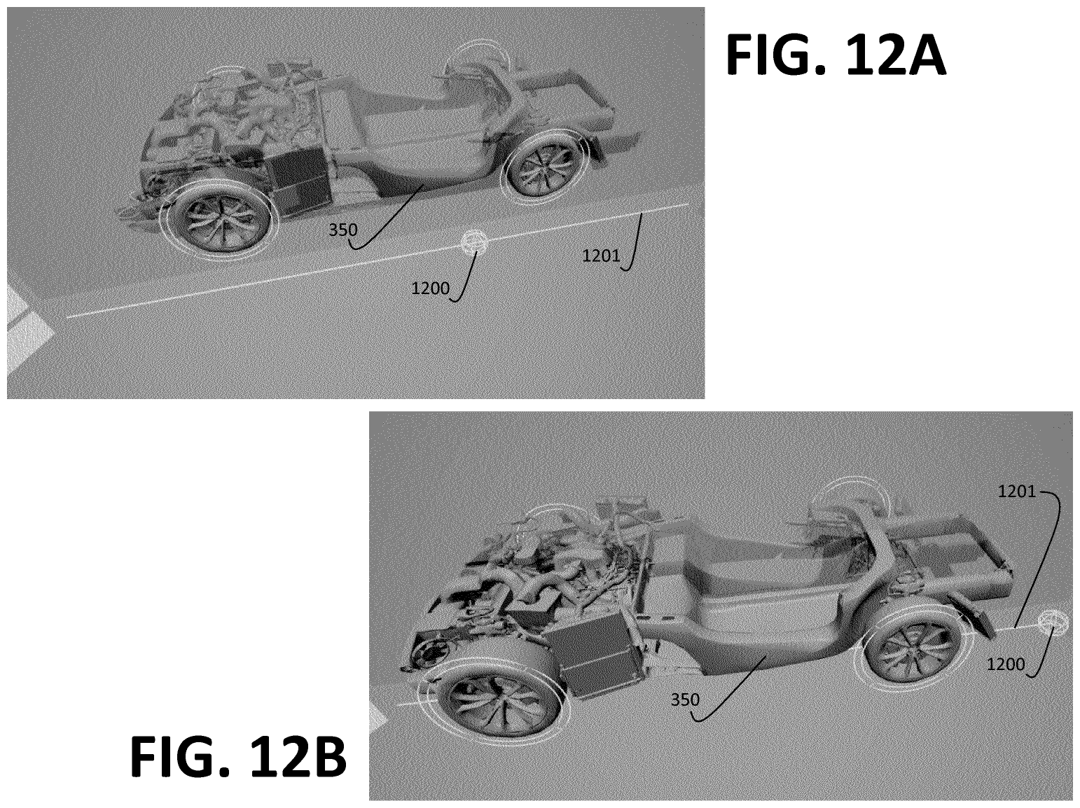

Referring now to FIG. 12A and FIG. 12B, two different screenshots of VR space 18 are shown. In FIG. 12A, the 3D core 350 is visible, as is a slide control 1200 on a sliding bar 1201. The user can move the controller 12 to align the virtual controller 19 with the slide control 1200. The user uses the buttons 14 on the controller 12, preferably the trigger button, to select the slide control 1200. The user presses and holds the trigger button to select the slide control 1200. Still holding the trigger button, the user can move the controller 12 left or right. The slide control 1200 moves left or right along the sliding bar 1201 accordingly. The depth of the 3D core 350 with respect to the drawing board also changes accordingly.

As the plane of the drawing board is moved deeper (into the plane of the paper as illustrated), more of the design becomes visible. Thus, in FIG. 12A, most of the design is below or behind the drawing board and only the uppermost features are fully visible. By contrast in FIG. 12B approximately half of the design is above the board and is visible while half is below and is invisible or is feint/suppressed.

In FIG. 12B, the user 11 has moved the slide control 1200 to the right along sliding bar 1201 with respect to FIG. 12B. The 3D core 350 now protrudes further out of the drawing board than in FIG. 12A.

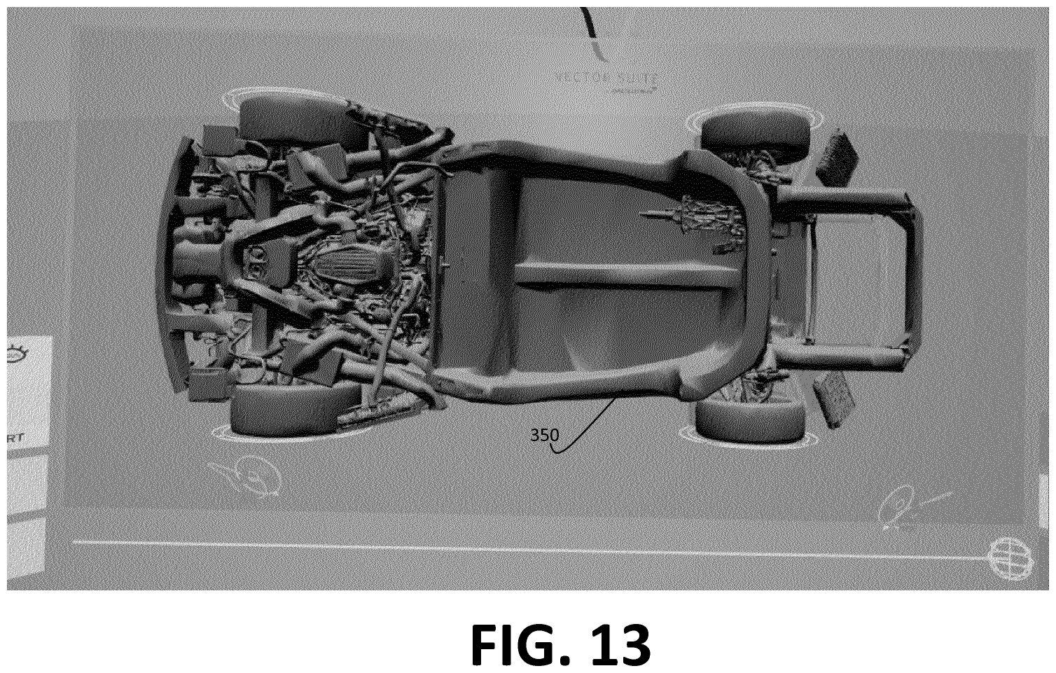

Referring now to FIG. 13, an example screenshot of VR space 18 is shown. The 3D core 350 is visible from a different angle. By pointing the controller to a control tool such as a slider (or wheel or the like), the entire image can be caused to rotate about a selected axis. There may be a first slider (e.g. vertically positioned) for rotating about a horizontal axis and a second slider (e.g. horizontally positioned) for rotating about a vertical axis.

Thus the entire design (with or without its core) can be viewed from any angle as if suspended in mid air in front of the user.

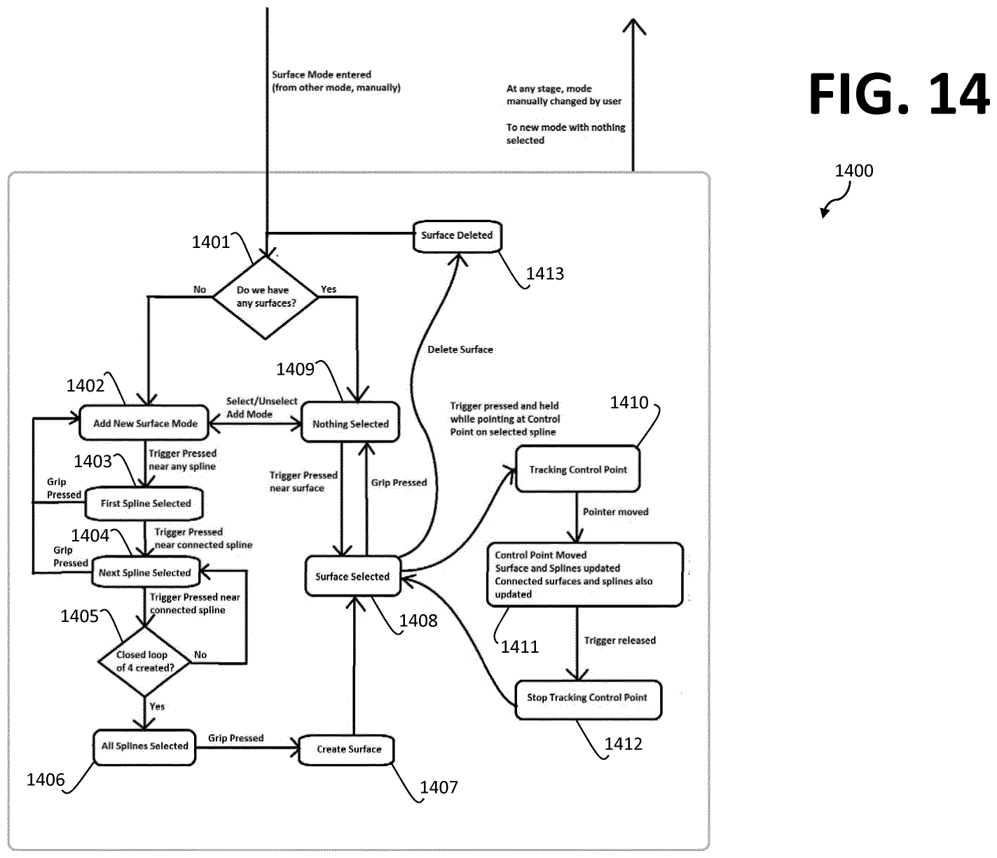

Referring now to FIG. 14, a flow diagram 1400 depicts a method of creating and editing surfaces in VR space. It should be appreciated that not all steps need be followed in this method.

Throughout this method, the application program is in Surface mode, having arrived there manually from another mode. At any stage, the user 11 can leave the method by manually selecting another mode. The user will then switch to the new mode with nothing selected.

The process begins at block 1401, with nothing selected. If there are no surfaces already present, the user proceeds to block 1402 by selecting the Add functionality. The user moves the controller 12 to align the virtual controller 19 with a point in VR space near a desired spline. The user uses the buttons 14 on the controller 12, preferably the trigger button, to select this spline.

Alternatively, the user can unselect Add mode and can proceed to block 1409.

At block 1403, a first spline has been selected. The user again moves the controller 12 to align the virtual controller 19 with a point in VR space near another desired spline. The user uses the buttons 14 on the controller 12, preferably the trigger button, to select this spline. The user can then proceed to block 1404.

Alternatively, the user can return to block 1402. The user uses the buttons 14 on the controller 12, preferably the grip button, to deselect the spline and the program returns to block 1402.

At block 1404, another spline has been selected, in addition to the first one. This process is then repeated until a closed loop of four splines has been selected. The user can then proceed through blocks 1405 and 1406 with all four splines selected. If four splines have not been selected, the user 11 returns to block 1404 to select more splines.

Note that four splines is merely a preferred example. A closed loop can be formed from three splines or indeed from two splines or one (looping back on itself). Indeed, a closed loop can be created from a multi-sided perimeter of splines.

Alternatively, the user can return to block 1402. The user uses the buttons 14 on the controller 12, preferably the grip button, to deselect the splines and the program then returns to block 1402.

The user uses the buttons 14 on the controller 12, preferably the grip button, to create a surface using the four selected splines (or other number of splines forming a closed loop). The user presses the grip button to create the surface.

At block 1407, the surface has been created, using the connected splines as a perimeter. The surface appears as a smooth, contoured patch of material defined by the continuous loop of splines which form its perimeter. This surface is automatically selected and so the user can proceed to block 1408.

Alternatively, upon entering Surface mode at block 1401, the user may see that one or more surfaces are already present. The user proceeds to block 1409, with nothing selected.

The user can select the Add functionality and proceed to block 1402.

Alternatively, the user can select one of the pre-existing surfaces. The user moves the controller 12 to align the virtual controller 19 with a point in VR space near a desired surface. The user uses the buttons 14 on the controller 12, preferably the trigger button, to select this surface. The user 11 then proceeds to block 1408.

At block 1408, a surface has been selected. The user sees the control points of all the perimeter splines, as well as a grid of controls points representing the breadth of the surface. The user can use the buttons 14 on the controller 12, preferably the grip button, to deselect a surface and the program returns to block 1409.

Alternatively, upon selecting a surface, the user can begin to edit the selected surface. At block 1410, the user tracks a control point on the selected surface. The user moves the controller 12 to align the virtual controller 19 with the desired control point of the selected surface in VR space. The user uses the buttons 14 on the controller 12, preferably the trigger button, to select the control point. The user 11 presses and holds the trigger button to select the control point.

Still holding the trigger button, the user moves the controller 12 freely, causing the control point to be dragged in a path matching the movements of the controller 12.

At block 1411, as the control point is being moved, the surface is recalculated to show the effect of the movements. The lines connecting the selected control point with other control points and/or line end points also move accordingly. Thus, reshaping a spline that forms part of a surface causes the surface to be reshaped.

At block 1412, the user stops tracking the control point. The user releases the trigger and the control point stops being moved. The user can then return to block 1408 for further editing.

The user may decide to delete the selected surface. The user selects the Delete functionality. At block 1413, the surface has been deleted. The splines that previously made up the surface remain. The program then proceeds back to block 1401.

Just as splines are mirrored, so too are surfaces and any other drawn or edited artefact (unless the mirror function is selectively disabled for a particular feature).

A drawing tool has been described with reference to examples of operation and examples of objects being drawn, but it will be understood by those in the art that these are non-limiting examples and that modifications of the apparatus, the method and the uses can be made without departing from the invention.

1-14. (canceled)

15. A tool for assisting in the preparation of drawings of a three-dimensional, 3D, object, including:
a stereoscopic display for creating a 3D virtual reality image of the object being drawn;
a hand-held pointer having a controller for receiving start-of-line and end-of line inputs;
a 3D tracker for tracking movement of the pointer in three dimensions in real space;
a position memory for recording the position of the pointer from start to end of a free-drawn line, whereby movement of the pointer in real space between the start-of-line and end-of-line inputs causes a first free-drawn line to be created in the 3D virtual space, and for repeating for a second free-drawn line;
a computing device for representing the first and second free-drawn lines respectively as at least one spline together with a series of straight lines to which the at least one spline is curve-fitted, the straight lines being connected by control points, for presenting the first and second free-drawn lines and their respective control points in 3D virtual space and for representing the pointer as a virtual pointer in the same 3D virtual space;
a selectable edit function, selectable by actuation of the controller, by which movement of the pointer in real space causes movement of the virtual pointer in the 3D virtual space and causes a control point of the first or second free-drawn line in the 3D virtual space to be selected and moved in three dimensions and thereby change the shape of the first or second free-drawn line in three dimensions;
a selectable join function, selectable by actuation of the controller, that, when active, permits a user to point to the first free-drawn line in virtual 3D space, select a point on the line, move that point to the second free-drawn line and cause the first free-drawn line to join the second free-drawn line, wherein joining of a plurality of lines in a closed perimeter causes a surface to be calculated and selectively displayed, the plurality of joined lines forming the perimeter of the surface.

16. The tool in accordance with claim 15, wherein the control point is selected by aligning the virtual pointer with the desired control point and using a button on the controller to select the control point, and the control point is moved by moving the pointer freely, causing the control point to be dragged in a path matching the movements of the pointer.

17. The tool in accordance with claim 15, wherein a set of adjoining straight lines are generated associated with the line, the straight lines being connected at control points and having a first line, a last line and at least one line therebetween, wherein the first line has the same gradient as the start of the free-drawn line, the last line has the same gradient as the end of the free-drawn line and the free-drawn line is fitted to the straight lines by a curve-fitting function.

18. The tool in accordance with claim 15, wherein the controller has infra-red sensors or an infra-red source and wherein complementary sources or sensors are provided for measuring the position of the controller.

19. The tool in accordance with claim 17 comprising a processor for computing the splines, the straight lines and the control points, and for selecting the straight lines and the control points according to a distance-minimizing function that minimizes distances between samples on the splines and samples on the straight lines.

20. The tool in accordance with claim 15 wherein the splines are constrained to third-order polynomial functions.

21. A method of drawing a line in three dimensions, comprising:
waving a pointer from a start position to an end position while viewing a track of the pointer using a virtual reality stereoscopic imaging device in which motion of the pointer is matched by motion of a virtual controller in three-dimensional virtual space;
recording the track of the pointer in three dimensions,
presenting, in the three-dimensional virtual space, a representation of the track as a first free-draw line together with a series of straight lines to which the line being drawn is curve-fitted, the straight lines being connected by control points that are also presented in the three-dimensional virtual space;
repeating the steps of waving, recording, and presenting for a second free-drawn line;
causing, using the virtual controller, one of the control points of the first or second free-drawn line to be selected and moved in three-dimensional virtual space;
re-calculating the curve-fitted line according to the new control point;
re-presenting the line; and
causing an end-of-line control point of the first free-drawn line to be moved to connect with the second free-drawn line in the virtual space and to be joined to the second free-drawn line, wherein joining of a plurality of lines in a closed perimeter causes a surface to be calculated and selectively displayed, the plurality of joined lines forming the perimeter of the surface.

22. The method of claim 21, wherein:
the control point is selected by aligning the virtual pointer with the desired control point in virtual space and by using a button on the controller to select the control point, and
the control point is moved by moving the pointer freely in real space, causing the control point to be dragged in virtual space along a path matching the movements of the pointer and
movement of the control point in virtual space is stopped by releasing the button on the controller.

23. The method of claim 21 wherein joining of the control point of the first line to a control point of the second line followed by movement of the joined control point causes both lines to be re-shaped.

24. The method of claim 21 wherein joining of the control point of the first line to a mid-line position on the second line causes movement of the control point of the first line to be constrained to the locus of the second line.

25. The method of claim 21 wherein selection of a virtual command to fill the surface causes the surface to be displayed with a selected color or texture.

26. The method of claim 21, further comprising:
selecting a plane of symmetry, wherein the step of presenting the line includes presenting a symmetrical image of the line and wherein the step of moving a control point on one side of the plane causes the line and its symmetrical image to be re-shaped and re-presented.

27. The method of claim 26, in which the line has a symmetrical image in the plane of symmetry, wherein causing a control point at the end of the line to be moved to the plane of symmetry causes the line and its symmetrical image to meet and join.
